(19) United States
(12) Patent Application Publication
(10) Pub. No.: US 2014/0316890 A1
(43) Pub. Date: Oct. 23, 2014

(54) Entity Bidding

(71) Applicant: Quixey, Inc., Mountain View, CA (US)

(72) Inventor: Tomer Kagan, Sunnyvale, CA (US)

(73) Assignee: Quixey, Inc., Mountain View, CA (US)

(21) Appl. No.: 14/259,873

(22) Filed: Apr. 23, 2014

Related U.S. Application Data
(60) Provisional application No. 61/815,179, filed on Apr. 23, 2013.

(51) Int. Cl. G06Q 30/02

(52) U.S. Cl. CPC G06Q 30/0256; G06Q 30/0275
USPC 705/14.54

(57) ABSTRACT

A method includes generating preliminary search results based on a search query received from a user device. The preliminary search results include search-result links to a plurality of native applications. Additionally, the method includes identifying a plurality of entity records that each include an association with one of the native applications of the preliminary search results. Each of the entity records includes an entity name and an entity link. Each entity link includes a reference to a state of a native application associated with the entity name of the entity record in which the entity link is included. Additionally, the method includes selecting one of the entity records based on an advertiser bid price associated with the entity record, retrieving the entity link from the selected entity record, and transmitting the search-result links and the retrieved entity link to the user device.

### CROSS-REFERENCE TO RELATED APPLICATION

This application claims the benefit of U.S. Provisional Application No. 61/815,179, filed on Apr. 23, 2013. The disclosure of the above application is incorporated herein by reference in its entirety.

### TECHNICAL FIELD

This disclosure relates to techniques for facilitating advertising on a search result page, and more particularly to bidding for advertisements on a search result page.

### BACKGROUND

Search result pages provide advertisers with a medium to advertise websites or other services. Typically, an advertiser can register one or more keywords and an advertisement with a company that provides the service of the search and/or provides the search result page, such that when a search engine user includes the one or more keywords in a search query, the search engine may also include the advertisements corresponding to the one or more keywords in the search result page. The search engine can sell the keywords according to different advertising schemes, including cost per number of impressions (e.g., number of views), cost per click-through, and cost per action. According to the cost per number of views model, the advertiser agrees to pay a specified amount each time the advertisement is displayed a specified number of times on a result page in response to a relevant search query. According to the cost per click-through model, the advertiser agrees to a pay a specified amount each time a user clicks on the advertisement displayed in response to a relevant search query. According to the cost per action model, the advertiser agrees to pay a specified amount each time a user performs a specific action in response to the advertisement being displayed. For example, the advertiser can agree to pay the specified amount when a user clicks on a hyperlink in the advertisement and makes a purchase from the website associated with the advertisement.

### SUMMARY

One aspect of the disclosure provides a method for facilitating advertising on a search result page. The method includes generating preliminary search results based on a search query received from a user device, identifying a plurality of entity records based on the search query, selecting one of the entity records based on an advertiser bid price associated with the one of the entity records, retrieving the entity link from the selected one of the entity records and transmitting the search-result links and the retrieved entity link to the user device. The preliminary search results include search-result links to a plurality of native applications. Each of the entity records includes an association with one of the plurality of native applications of the preliminary search results, wherein each entity record includes an entity name and an entity link and wherein each entity link includes a reference to a state of a native application associated with the entity name of the entity record in which the entity link is included.

Implementations of the disclosure may include one or more of the following features. In some implementations, generating preliminary search results includes generating the preliminary search results based on the relevance of the preliminary search results to terms of the search query. Each of the search-result links may include a reference to a different native application along with instructions for the respective native application to launch on the user device. N of the plurality of entity records may each include a field that lists one or more native applications with which the entity record is associated, where N is an integer that is greater than or equal to 1. For each entity record, the entity link included in the entity record may indicate which native application is associated with the entity record.

In some examples, one of the entity records includes an entity information field along with the entity name and the entity link. The entity information field may include information about the entity name, wherein the reference to the state of the native application included in the entity link may be a reference to the location from where the information of the entity information field was retrieved.

In some implementations, transmitting the retrieved entity link to the user device includes transmitting data indicating that the retrieved entity link is an advertisement. The state of the native application referenced in an entity link may include data related to the entity name. Additionally or alternatively, the entity name may be the name of a product for sale in the state of the native application or the name of a business described in the state of the native application.

In some examples, selecting one of the entity records based on the advertiser bid price associated with the one of the entity records includes identifying an advertisement entry in an advertisement database. Identifying the advertisement entry may include detecting an entity name included in the advertisement entry that matches the entity name in the one of the entity records. Selecting one of the entity records may further include determining advertiser bids associated with each of the plurality of entity records and selecting the one of the entity records that is associated with the highest bid price of the determined advertiser bid prices.

Identifying the plurality of entity records may include performing a search forwarding operation. The search forwarding operation includes providing the search query to servers of one or more of the plurality of native applications of the preliminary search results, receiving results from the servers of the one or more of the plurality of native applications and identifying the plurality of entity records based on the received results.

In some examples, the method further includes determining a category implicated by the search query. Identifying the plurality of entity records may include identifying entity records that include an entity category that matches the category implicated by the search query. The entity category of an entity record may indicate a category to which the entity name and entity link of the entity record belong. Additionally or alternatively, selecting the one of the entity records may include identifying an advertisement entry among a plurality of advertisement entries in an advertiser database. Identifying the advertisement entry may include determining that the advertisement entry includes an entity category that matches the entity category included in the one of the entity records. The advertisement entry may further include the advertiser bid price.

In some implementations, the method includes determining a category and a subcategory implicated by the search query. Identifying the plurality of entity records may include identifying the entity records that include both an entity category and an entity subcategory that match the category and the subcategory implicated by the search query, respectively. The entity category and entity subcategory of an entity record may indicate a category and subcategory to which the entity name and entity link of the entity record belong.

In some implementations, the method includes generating the preliminary search results based on the relevance of the preliminary search results to terms of the search query. The generated preliminary search results include the search-result links and a set of additional links to native applications. Additionally, the method includes identifying the plurality of entity records by identifying entity records that include an entity link that matches at least one of the additional links. Retrieving the entity link for transmission may include using one of the additional links that match one of the entity links as the retrieved entity link.

Another aspect of the disclosure provides a system for facilitating advertising on a search result page. The system includes a storage device storing an entity database that includes a plurality of entity records and a processing device that executes computer readable instructions. Each of the entity records includes an association with a native application, wherein each of the entity records includes an entity name and an entity link. Each entity link includes a reference to a state of the native application associated with the entity name of the entity record in which the entity link is included. The computer readable instructions, when executed by the processing device, cause the processing device to generate preliminary search results based on a search query received from a user device, identify a set of entity records in the entity database, select one of the entity records in the set of entity records based on an advertiser bid price associated with the one or the entity records, retrieve the entity link from the selected one of the entity records and transmit the search-result links and the retrieved entity link to the user device. The preliminary search results include search-result links to a plurality of native applications. Identifying each entity record in the set of entity records includes determining that the entity record includes an association with one of the plurality of native applications of the preliminary search results.

In some implementations, each of the search-result links includes a reference to a different native application along with instructions for the respective native application to launch on the user device. The computer readable instructions may cause the processing device to transmit the retrieved entity link to the user device along with data indicating that the retrieved entity link is an advertisement. The state of the native application referenced in an entity link may include data related to the entity name.

In some examples, the storage device stores an advertiser database that includes a plurality of advertisement entries. Each of the advertisement entries may include an entity name and an advertiser bid price. The computer readable instructions may cause the processing device to identify a set of advertisement entries in the advertiser database that includes entity names that match entity names included in the set of entity records, select an advertisement entry in the set of advertisement entries based on the advertiser bid price associated with the advertisement entry and select the one of the entity records that includes the same entity name as the selected advertisement entry.

In some implementations, N (where N is an integer that is greater than or equal to 1) of the entity records in the entity database include entity categories that indicate a category to which the entity name and entity link of the entity record belong. The computer readable instructions may further cause the processing device to determine a category implicated by the search query and identify the set of entity records by identifying entity records that include an entity category that matches the entity category implicated by the search query.

Yet another aspect of the disclosure provides a non-transitory computer-readable storage medium. The storage medium includes instructions that cause a processing device to generate preliminary search results based on a search query received from a user device, identify a plurality of entity records, select one of the entity records based on an advertiser bid price associated with the one of the entity records, retrieve the entity link from the selected one of the entity records and transmit the search-result links and the retrieved entity link to the user device. The preliminary search results include search-result links to a plurality of native applications. Each of the entity records includes an association with one of the plurality of native applications of the preliminary search results, wherein each of the entity records includes an entity name and an entity link, and wherein each entity link includes a reference to a state of a native application associated with the entity name of the entity record in which the entity link is included.

### DESCRIPTION OF DRAWINGS

FIG. 1 shows an example user device in communication with an example search server.

FIG. 2 is a flow diagram that illustrates an example method for generating an entity link within search results.

FIGS. 3-4 show an example search server and data flow thereof.

FIG. 5 is a flow diagram that illustrates an example method for performing a search for applications to include in search results.

FIGS. 6A-6D show a variety of different example entity records.

FIGS. 7A-7C show a variety of different example advertisement entries.

FIGS. 8-11, and 13 are flow diagrams that describe example implementations of the search server in which the search server generates entity links to be included in search results.

FIGS. 12A-12B illustrate example graphical user interfaces (GUIs) that may be generated on a user device.

### DETAILED DESCRIPTION

The figures and the following description relate to example implementations by way of illustration only. It should be noted that from the following discussion, alternative implementations of the structures and methods disclosed herein will be readily recognized as viable alternatives that may be employed without departing from the scope of the disclosure.

An issue with keyword advertising is that advertisers whose services may be similarly aligned may bid against one another for keywords. For example, Denny's Inc., which operates DENNY'S® diners, and Yelp Inc., which offers the YELP® application that provides on-line reviews of establishments such as restaurants, may both provide bids for the keywords “late night diners by me,” despite the fact that the two advertisers do not compete with one another and may actually have a symbiotic relationship. In particular, the YELPs application has an avid user base because establishments like DENNY'S® diners exist, and DENNY'S® diners benefit from services like the YELP® application, which raise awareness for local establishments. Thus, two advertisers that may derive benefit from one another may actually be bidding against one another when it comes to keyword advertising. The entity bidding and advertising techniques of the present disclosure may promote the symbiotic relationships between aligned parties in a search engine advertising campaign and may eliminate the need for search engine optimization.

Entity bidding can refer to a type of advertising where an advertiser bids on an entity. An entity may refer to an entity name selected by an advertiser. In some examples, an entity may refer to an entity name and an associated entity category/subcategory selected by an advertiser. An advertiser may bid on one or more different entities. In some examples, an advertiser for a particular entity may have separate bids for the same entity when advertised in different contexts. For example, an entity may have different bids in response to variables such as, but not limited to, general category, geographical location, time of day, and/or position on a search result page. An advertiser may generally refer to any party that advertises on a search result page generated by a search engine, either to advertise its own goods and services or the goods and services of a related party. An advertiser can advertise, for example, a business, products, services, media content, or any other suitable item of commerce referenced in an application.

An entity selected by an advertiser can be displayed or referenced in connection with an application that appears as a search result of a search result page provided by a search engine (e.g., an application search engine and/or function search engine). For example, the search result page may display a result for the ROTTEN TOMATOES® application by Flixster, Inc. as an organic search result and may also display an advertisement of a link to a page of the ROTTEN TOMATOES® application. In one example, the search result page may display a link to the ROTTEN TOMATOES® native application along with a link to an entry for a new movie on the ROTTEN TOMATOES® native application. As another example, the search engine result page may display a link to the ROTTEN TOMATOES® web application along with a web link to a new movie on the ROTTEN TOMATOES® web application.

A search server of the present disclosure receives a search query from a user device and generates search results in response to the received search query. The search server transmits the search results to the user device that provided the search query. The search results include links to software applications (referred to herein as “applications”). For example, the search results may include a plurality of links to native software applications (hereinafter “native applications”) and/or web software applications (hereinafter “web applications”). A link to a native application may be referred to herein as a native application link. As described herein, a native application link may include an application resource identifier that references a state (e.g., a screen or other function) of a native application. A link to a web application may be referred to herein as a web link. As described herein, a web link may include a web resource identifier, such as a uniform resource locator (URL).

A user device may generate (e.g., render) user selectable links on a graphical-user interface (GUI) based on the search results received from the search server. A user may select the user selectable links included in the search results on the user device. For example, the user may tap or click the user selectable links included in the search results in order to select the link. In response to the selection of a native application link (e.g., including an application resource identifier), the user device may launch the native application referenced in the native application link (e.g., in the application resource identifier) and set the native application in a state specified by the application resource identifier. In response to the selection of a web link (e.g., including a web resource identifier), the user device may launch the web browser of the user device and retrieve a resource identified by the web resource identifier (e.g., URL) of the web link.

Initially, the search server may generate a preliminary set of search results in response to receiving a search query. The preliminary set of search results may include a plurality of links (e.g., native application and/or web links). The links included in the preliminary set of search results may be included in the search results as links to native applications and/or web applications. The links in the preliminary set of search results may be organic search results, which may be referred to herein as “search-result links” in some examples.

As described herein, the search server may also select an advertised entity to include along with the preliminary set of search results. An entity may refer to products, services, media content, or any other suitable item of commerce referenced in an application. The search server may generate a link (e.g., a native application link or web link) for the selected entity to be included in the search results that are displayed to the user on the user device. The link for the selected entity may be referred to as an “entity link.” Accordingly, the search results may include search-result links and one or more entity links. As described herein, the entity link may include text and/or images that indicate that the entity link is an advertised link.

The search server may include an entity database that the search server can use to implement the techniques of the present disclosure. The entity database may include entity records (e.g., entity records 600, 606, 616, 618). An entity record may include information related to an entity (e.g., an entity name and category/subcategory), which may be advertised in search results in some examples. For example, an entity record may include an entity name and an entity link to a state of an application associated with the entity name. In one example, an entity record having the entity name “McDonald's” may include an entity link to an entry corresponding to the MCDONALD'S® franchise in an application, such as the YELP® application or the TRIPADVISOR® application by TripAdvisor LLC.

An entity, as described by an entity record, may be associated with one or more applications (e.g., native applications). For example, an entity may be associated with one or more native applications and/or web applications. An association between an entity and an application may exist when the application includes a reference to the entity described by the entity record. For example, an association between an entity and an application may exist when the application outputs information related to the entity described by the entity record. In one example, if an application is a native application, the native application may include native application links to application states that include or describe the entity in some way. In a more specific example, a restaurant review application may be associated with a MCDONALD'S® restaurant entity because the restaurant review application includes a page reviewing a MCDONALD'S® restaurant.

An association between an application and an entity may be defined in an entity record. In one example, an association between an application and an entity (e.g., entity name) may be enumerated in the entity record. For example, an entity record may include a list of one or more applications with which the entity is associated. In another example, an association between an application and an entity may be defined by the entity link(s) included in the entity record. For example, the entity link to the application (e.g., the native application link) may include a reference to the application, such as the application name. In a specific example, an entity link to an application state of the YELP® native application may include the name “Yelp” in the application resource identifier. An entity may be associated one or more different applications.

As described herein, the search server may select an advertised entity to include along with the preliminary set of search results. An advertiser may sponsor an entity to be included as an advertised entity in the search results. For example, the advertiser may select an entity name to advertise and then set a bid on the entity name. The bid may indicate an amount of money for a specific action in association with the entity name in the search results. The advertiser's selection of the entity name and the bid may be included in an advertisement entry (e.g., advertisement entries 700, 708, 714) in the advertiser database, described hereinafter.

An entity may be advertised along with organic search results in the following manner. Initially, the search server may generate a preliminary set of search results in response to receiving the search query. The search server may then identify a set of entities (e.g., entity records) associated with the applications listed in the preliminary set of search results. The search server may then select an entity (e.g., entity record), from the set of entities, that is associated with an advertiser bid. For example, the search server may select the entity that is associated with the highest bid price. In a more specific example, the search server may determine which of the entities of the set of entities is associated with the highest bid price based on data included in advertisement entries associated with the entities. The search server may then generate an entity link (e.g., a native application link or web link) for the selected entity to be included in the search results that are displayed to the user on the user device.

In some examples, an entity record may include an entity category field that indicates a category in which the data included in the entity record belongs. For example, the entity category field may indicate a category in which the entity name, entity information, and entity link belongs. In some implementations, an advertiser can place a bid on the combination of the entity name and the entity category. In these examples, the search server may generate an entity link for advertisement when both the entity name and the entity category are implicated by the user in some manner. As described herein, where a bid is placed on the combination of the entity name and the entity category, the search server may determine a first set of entities that could be outputted by an application indicated in the search results and a second set of entities that were bid on in relation to the category implicated by the search query. The search server may then determine an intersection of the first and second sets of entities and determine which one or more entities in the intersecting set of entities to include in the advertising in connection with the search results based on the bids provided for those entities. Example categories can include, but are not limited to, restaurants, movies, clothing, and sports. As described herein, categories can be broadly defined such that different subcategories can correspond to (e.g., fall under) a single category.

In some examples, a single entity name can be associated with multiple different categories. For example, the entity name “TOY STORY®” can be associated with the entity category “movies” and the entity category “book.” In some examples, an entity category may include one or more subcategories. In these examples, an entity name can be associated with an entity category and the one or more subcategories. For example, the entity name “MCDONALD'S®” may be associated with the entity category “restaurants” and the subcategory “fast food.” As described herein, an advertiser can bid on an entity according to one or more categories and one or more subcategories.

In some examples, an entity may be associated with multiple different applications. In these examples, an entity record may include multiple entity links. Accordingly, the search server may generate different entity links for the same entity (e.g., entity name and category), depending on the applications included in the preliminary search results. For example, if an entity record for MCDONALD'S® includes links to both the YELP® native application and the TRIPADVISOR® native application, the MCDONALD'S® link to the YELP® native application may be displayed when the preliminary search results include results for the YELP® native application. In this example, the MCDONALD'S® link of the TRIPADVISOR® native application may be displayed when the preliminary search results include results for the TRIPADVISOR® native application.

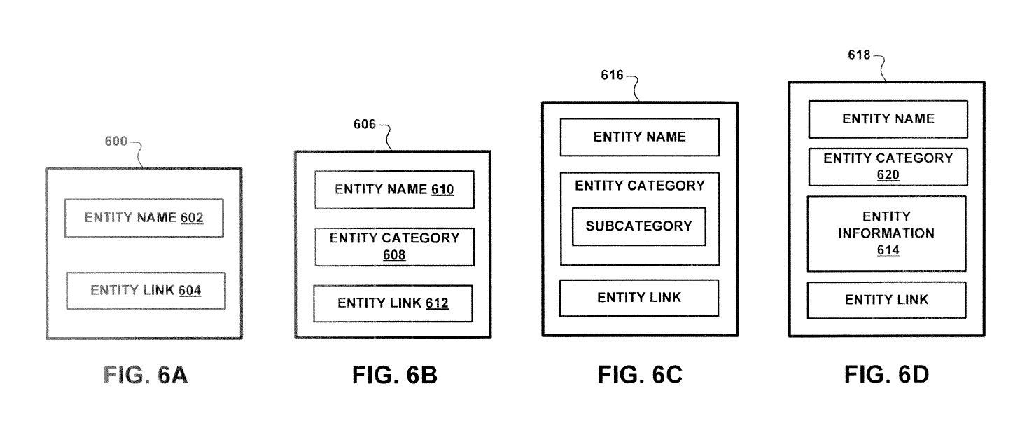

In some implementations, an entity record may include additional information. For example, an entity record may include an entity information field (e.g., entity information 614 of FIG. 6D) that includes information about the entity described in the entity record. An entity record can also include a field that indicates the source(s) of the information included in the entity record. For example, the entity record may include links (e.g., native application links and/or web links), such as URLs, indicating the source from which at least some of the information in the entity record was retrieved. These links may be used as entity links that are returned in the search results in some examples. Accordingly, if the entity information field includes information derived from an application (e.g., a native application), the link to the application (e.g., the native application link) from which the information was retrieved may be used as an entity link.

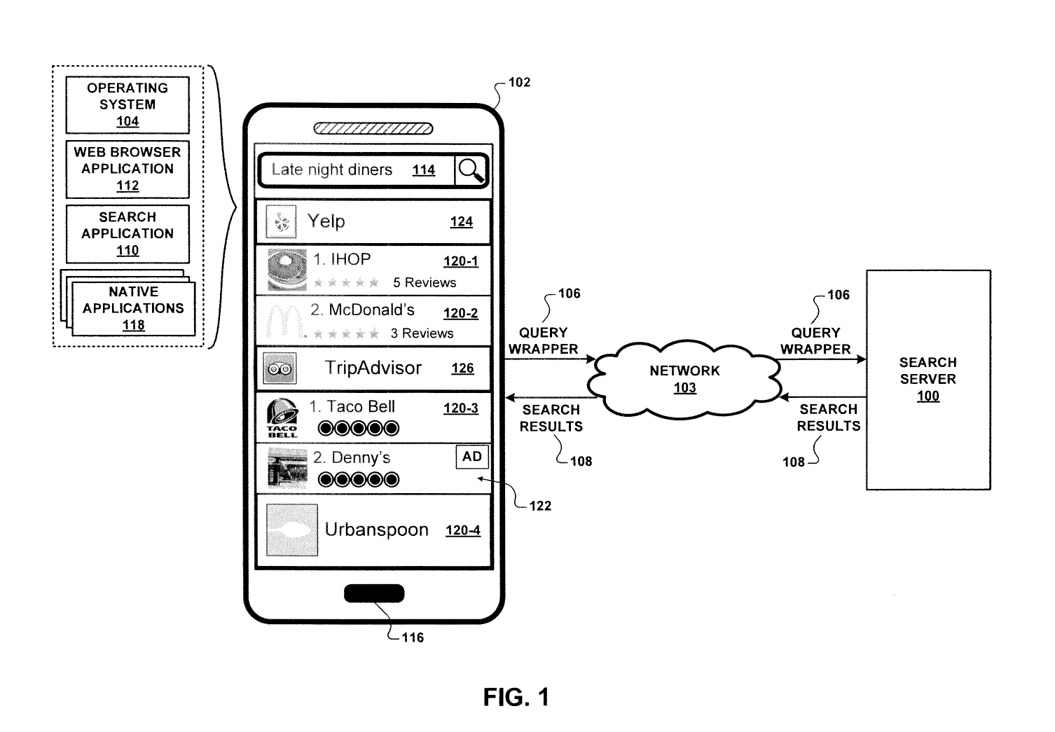

FIG. 1 illustrates a search server 100 that facilitates entity bidding and advertising. The search server 100 is in communication with a user computing device 102 (hereinafter “user device 102”) via a network 103. The network 103 through which the search server 100 and the user device 102 communicate may include various types of networks, such as a local area network (LAN), wide area network (WAN), and/or the Internet. Although a single user device 102 is illustrated in FIG. 1, the search server 100 may be in communication with any number of user devices. In some implementations, the search server 100 is further configured to communicate with partner servers (not shown), which may act as proxies that receive search queries from user devices and provide the search queries to the search server 100.

The user device 102 of FIG. 1 is illustrated as a mobile computing device (e.g., a mobile phone). Although the user device 102 is illustrated as a mobile computing device, the user device 102 may be any suitable computing device, e.g., stationary computing device (e.g., PC) or another type of portable computing device (e.g., a tablet computing device or laptop). User devices may also include other computing devices having other form factors, such as computing devices included in vehicles, gaming devices, televisions, or other appliances (e.g., networked home automation devices and home appliances).

User devices may use a variety of different operating systems. In the example of FIG. 1 where the user device 102 is a mobile device, the user device 102 may run an operating system including, but not limited to, Android developed by Google Inc., iOS developed by Apple Inc., or Windows Phone developed by Microsoft Corporation. Accordingly, the operating system 104 running on the user device 102 may include, but is not limited to, one of ANDROID®, IOS®, or WINDOWS PHONE®. In an example where a user device is a laptop or desktop computing device, the user device may run an operating system including, but not limited to, MICROSOFT WINDOWS® by Microsoft Corporation, MAC OS® by Apple, Inc., or Linux. User devices may also access the search server 100 while running operating systems other than those operating systems described above, whether presently available or developed in the future.

In general, the user device 102 may communicate with the search server 100 using any application that can transmit search queries (e.g., in query wrapper 106) to the search server 100 and receive search results 108 from the search server 100. In some examples, the user device 102 may execute an application that is dedicated to interfacing with the search server 100, such as an application dedicated to searches (e.g., search application 110). For example, the user device 102 may communicate with the search server 100 using a native search application installed on the user device 102. As another example, the user device 102 may communicate with the search server 100 using a more general application, such as a web-browser application 112.

The application executed by the user device 102 to communicate with the search server 100 may display a search field 114 on a GUI in which the user may enter search queries. A search query includes one or more terms and is a request for information (e.g., search results 108) from the search server 100. For example, a search query may be directed to retrieving a list of links to application functionality (e.g., native application functionality) in examples where the search server 100 is configured to generate a list of application links (e.g., native applications links) as search results 108. A search query directed to retrieving a list of links to native applications may indicate a user's desire to access functionality of one or more native applications described by the search query.

The user device 102 receives a search query from a user via a user interface. The user interface of the user device 102 may include mechanical buttons (e.g., button 116), a microphone, and/or a touchscreen, among other user interface elements. A user can enter a search query into the search field 114 displayed in the GUI of the user device 102 via a touchscreen and/or a microphone of the user device 102. The user device 102 generates a query wrapper 106 in response to the provided search query and other information (e.g., geo-location data). In some implementations, the query wrapper 106 includes information such as a current location of the user device 102 (e.g., a geo-location), an IP address of the user device 102, account information of a user (e.g., username), a platform of the user device 102 (e.g., OS version and/or device type), a current time, language and dialect information, and/or any other suitable information.

The user device 102 may receive a set of search results 108 from the search server 100 that are responsive to the search query transmitted to the search server 100. The user device 102 may be executing a search application 110 including a GUI that displays the search results 108 received from the search server 100. For example, the search application 110 used to transmit the search query to the search server 100 may also display the received search results 108 to the user. The GUI of the search application 110 can display the search results 108 to the user in a variety of different ways, depending on the information that the search server 100 transmits to the user device 102. In examples where the search results 108 include a list of application links, the search server 100 may transmit the list of application links to the user device 102 along with additional data (e.g., images and/or text) to be displayed in user selectable links. In some examples, the GUI may display the search results 108 to the user as a list of user selectable links including text and images. The text and images in the links may include the application names, text describing the application links, and additional information.

In some examples, the GUI may display the search results 108 as a list of links arranged below the search field 114. The search application 110 can receive a ranked list of links. Alternatively, the search application 110 can arrange the links in order by result scores associated with the links. As described herein, the result scores may be scores assigned to the links by the search server 100 to indicate the relevance of the links to the search query. The user device 102 may arrange the links in order by the result scores associated with the links. In some examples, as illustrated in FIG. 1, the user device 102 may group the links together if the links are related to the same native application.

The search server 100 receives the query wrapper 106 and determines search results 108 in response to the query wrapper 106. In operation, the search server 100 can deliver the search results 108 to the user device 102, which the user device 102 may present in a search results page via a user interface. An example search result page is illustrated in FIG. 1. As will be discussed in greater detail, the search results can include links and/or views to states of applications (e.g., native applications) corresponding to advertised entities. A link to an application can be displayed in a textual format or a non-textual format, such as an icon of an application. A resource identifier can be embedded in the text and/or icon.

In some implementations, the search server 100 is configured to identify applications (e.g., native application links or web links) that perform a certain function or are otherwise relevant to the search query. As described herein, the search server 100 may be configured to perform one or more of a function search, an entity search, an application deep search, and a text based search in order to identify applications. The search results 108 can include links to applications that can either perform a functionality implicated in the search query and/or can be used to respond to the search query. For example, a search query can be “help me organize my finances.” In response to such a search query, the search server 100 may identify applications that can help a user organize their credit cards, organize their bank accounts, and/or manage their investments. As another example, a search query can be “movies playing tonight in my area.” In response to such a search query, the search server 100 may identify applications (e.g., maps applications) that can be used to locate movie theatres and that provide reviews or information related to movies or television shows. The foregoing examples are not intended to limit the scope of the disclosure.

In some implementations, the search server 100 includes an entity (e.g., an entity link) in the search results 108 by providing a resource identifier that links to a state of an application corresponding to the entity in the search results 108, whereby the application was identified in the preliminary search results. For example, the resource identifier may link to a page of an application that describes the entity, reviews the entity, provides a location of the entity, or provides other information about the entity. In some examples, the resource identifier can be included in a link (e.g., a hyperlink) to a native application. A resource identifier that links to a state of a native application can be referred to as an “application resource identifier.” In some examples, the resource identifier may be a link (e.g., a hyperlink) to a web application. A resource identifier that links to a state of a web application can be referred to as a “web resource identifier.”

A native application can be an application that is installed on a user device 102. An application resource identifier linking to the native application can be a link that, when selected, instructs the user device 102 to launch the native application. For example, an application resource identifier may instruct at least one of the operating system 104 and the search application 110 to launch the native application referenced in the application resource identifier. The application resource identifier may also instruct the launched native application to be set into an application state specified by the is application resource identifier (e.g., by a tail portion of the application resource identifier). Accordingly, an application resource identifier can be a link that causes a native application to launch to a particular state. For example, in an online shopping application, a native application link can link to a state indicating a particular item, e.g., a particular pair of shoes, or class of items, e.g., the splash page for the shoes.

The native applications 118 are applications that are installed on the user device 102 (e.g., native applications). As described herein, search-result links to native applications and entity links to native applications may be included in the search results 108. When a native application link (e.g., search-result link and/or entity link) to one of the installed native applications 118 is included in the search results 108, the user may select the native application link in order to launch the native application installed on the user device 102 and set the native application to a state specified in the native application link. As described hereinafter, the user device 102 in FIG. 1 may have the YELP®, TRIPADVISOR®, and URBANSPOON® native applications installed.

A web resource identifier linking to a web application can be a link that, when selected, instructs the operating system 104 and/or web browser application 112 to request a web page from a web server indicated by at least a portion of the web resource identifier. In some implementations, the search server 100 can provide a screen shot or a window view of a native or web application in the search result page that indicates a state of the application that corresponds to the advertised entity. For example, the search server 100 can provide a screen shot or a window view of a native or web application in the search result pages that indicates a state of the application that corresponds to the advertised entity.

As previously mentioned, advertisers can provide bids on entities. For example, advertisers can provide bids on entity names. As another example, advertisers can provide bids on entity names in relation to categories and subcategories associated with the entity names. Accordingly, in some examples, when a search query implicates a category bid on by an advertiser and an application in the search results 108 is associated with the entity, the search server 100 can include the entity (e.g., an entity link) intended to be advertised in the search results 108.

A bid can be a price that the advertiser agrees to pay in response to an action being performed by the search server 100 or the user. In some implementations, the search server 100 utilizes a “cost per impression” bidding model, whereby the advertiser agrees to pay the bid price each time the entity (e.g., an entity link) is displayed in the search results 108. Additionally, or alternatively, the search server 100 may implement other types of bidding models, e.g., cost per click through or cost per action. For purposes of explanation, however, reference is made to a cost per impression bidding scheme. The advertiser may provide a bid by selecting an entity name, and category in some examples, and by agreeing to pay the bid price to the provider of the search server 100 when a specific action is performed, e.g., the search server 100 includes an entity link in the search results 108. For instance, McDonalds Corp. may associate the entity “MCDONALD'S®” to the category “restaurants” and may agree to pay ten cents per impression. In this scenario, the search server 100 may include a link to the entity “MCDONALD'S®” in the search results 108 when the applications that are identified in response to a search query are associated with the MCDONALD'S® entity and the category implicated by the search query is “restaurants.” For example, if the user provides a search query of “find a cheap hamburger.” the search results 108 may include the YELP® application, and the YELP® application may have one or more pages that review MCDONALDS® franchise locations. In this scenario, the search result page may include a link to a YELP® review of a nearby MCDONALD'S® restaurant location in the search results in connection with the YELP® application, and McDonalds Corp. (or a franchisee) pays ten cents to the provider of the search server 100. In some implementations, the advertiser provides a bid on the entity without limiting the entity to a certain category. In these implementations, the advertiser can bid on the entity (e.g., the entity name), such that each time a search result includes an application that is associated with the entity, the entity may be included in the search results based on the bid associated with the entity relative to bids provided by other advertisers.

In some implementations, the advertiser can add stipulations to the bid. For example, the advertiser can limit the bids to only cover search queries originating from specific geographic areas. The advertiser may also limit the daily, weekly, or monthly budget to be spent on advertising the entity, e.g., no more than $10,000 a day. Furthermore, an advertiser may provide additional bids to associate entities with additional categories and/or subcategories.

FIG. 1 shows an example search result page on the user device 102. The search result page includes a plurality of native application links 120-1, 120-2, 120-3, 120-4 which also may be referred to as “displayed search results 120.” Each of the displayed search results 120 in FIG. 1 may represent links to native applications that were rendered by the search application 110. Some of the links 120 displayed in FIG. 1 may represent organic search results. Link 122 represents an entity link to an advertised entity. The entity link 122 may include data indicating that the entity link is an advertisement (e.g., the word “AD” in FIG. 1). Search-result links may refer to links corresponding to organic search results (e.g., links 120) that may be based on the relevance of the links to the search query. Accordingly, the displayed search results 120 illustrated in FIG. 1 may be referred to as search-result links.

Each of the native application links 120 may include an application resource identifier. It may be assumed that the YELP® native application, TRIPADVISOR® native application, and URBANSPOON® native application are installed on the user device 102. Accordingly, in response to selection (e.g., a touch or click) of one of the native application links 120, the user device 102 may launch the native application referenced in the link and perform one or more operations according to the application resource identifier in order to set the launched native application into a state specified by the application resource identifier.

Native application links 120-1, 120-2 link to the YELP® native application. The GUI includes a first header 124, including the name “Yelp,” under which the native application links 120-1, 120-2 are arranged. The first header 124 may indicate that the native application links 120-1, 120-2 arranged below the first header 124 are associated with the YELP® native application. The GUI also includes a second header 126, including the name “TripAdvisor.” that indicates that the native application link 120-3 is a native application link for the TRIP ADVISOR® native application. The search results also include a native application link 120-4 to the URBANSPOON® native application.

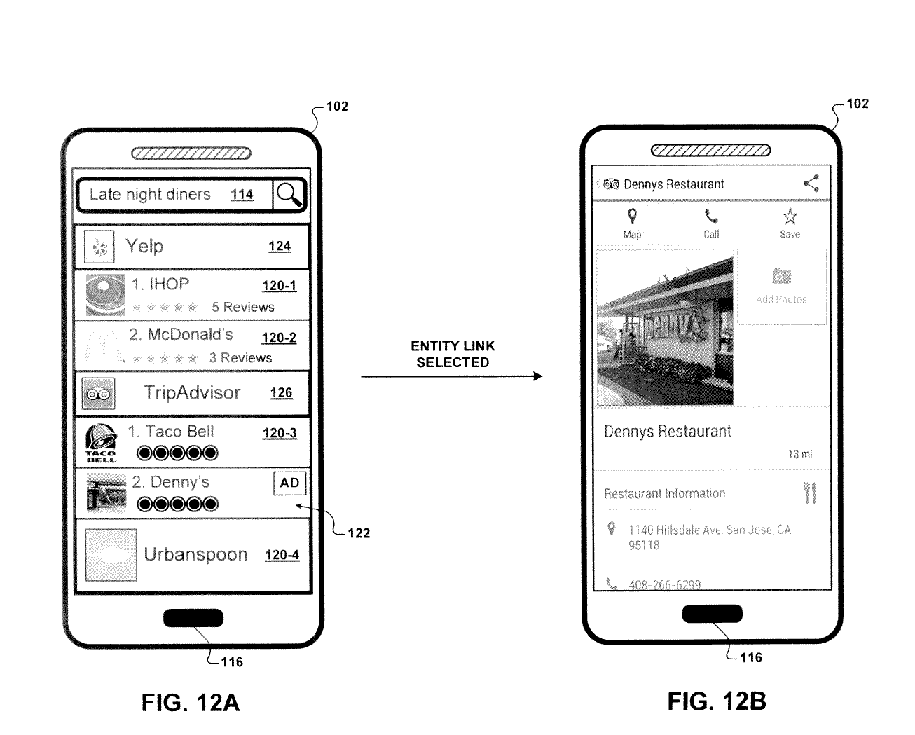

Selection of native application link 120-1 may cause the user device 102 to launch the YELP® native application and retrieve the IHOP® restaurant entry of the YELP® native application. For example, in response to the user selection, the user device 102 can launch the YELP® native application and then the YELP® native application can retrieve an entry corresponding to an IHOP® restaurant. In response to user selection of native application link 120-2, the user device 102 may launch the YELP® native application and retrieve a MCDONALD'S® restaurant entry of the YELP® native application. Selection of native application link 120-3 may cause the user device 102 to launch the TRIPADVISOR® native application and retrieve a TACO BELL® restaurant entry of the TRIPADVISOR® native application. In response to selection of native application link 120-4, the user device 102 may launch the URBANSPOON® native application to a default state. In the illustrated example, the search results page also includes an entity link 122. The entity link 122 is a link to a DENNY'S® restaurant entry in the TRIPADVISOR® native application. The entity link 122 may include an application resource identifier that instructs the user device 102 to launch the TRIPADVISOR® native application and causes the TRIPADVISOR® native application to access an entry corresponding to a DENNY'S® restaurant of the DENNY'S® chain of restaurants. Accordingly, in response to user selection of the entity link 122, the user device 102 may launch the TRIPADVISOR® native application and set the TRIPADVISOR® native application into a state that accesses a DENNY'S® restaurant entry. The response of the user device 102 to selection of the entity link 122 is illustrated in FIGS. 12A-12B.

According to some implementations, the search server 100 generates the search result page of FIG. 1 in the following manner. The search server 100 receives the search query “late night diners” and generates the search-result links 120 in response to the search query. The search server 100 then identifies entities that were associated with at least one of the applications indicated in the search result page. With respect to the search result page of FIG. 1, the search server 100 may have identified one or more entities for the YELP® native application, the TRIPADVISOR® native application, and the URBANSPOON® native application. One of the entities the search server 100 determines to be associated with the applications included in the search results was the “DENNY'S®” entity, which is associated with the TRIPADVISOR® native application.

The search server 100 selected the “DENNY'S®” entity that was associated with the TRIPADVISOR® native application for advertisement. For example, the search server 100 may have selected the “DENNY'S®” entity associated with the TRIPADVISOR® native application because the “DENNY'S®” entity was the entity having the highest associated advertiser bid. The foregoing example is provided for context only and not intended to be limiting. Entity bidding and advertising is applicable to many other types of queries and applications. Entity bidding allows all types of advertisers to advertise in more constrained types of search engines, such as application search engines. Moreover, entity bidding advertising may allow advertised entities to appear in organic search results, as opposed to taking up valuable real estate in the search results page.

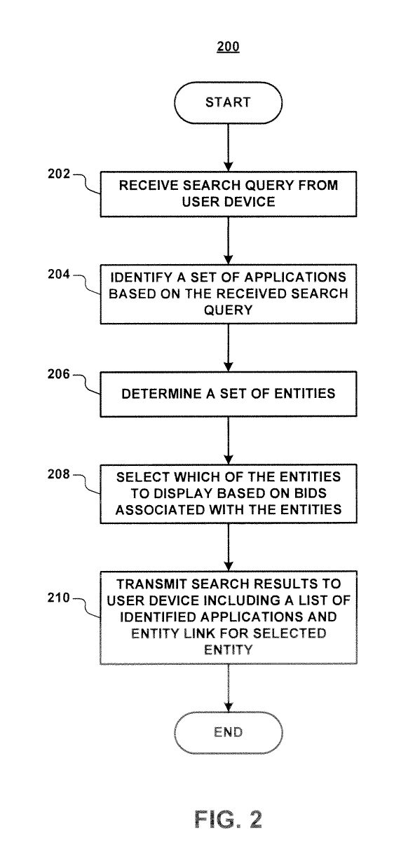

FIG. 2 is a flow diagram that illustrates an example method 200 for generating an entity link within search results. The method 200 is described with respect to the search server 100 and the user device 102 of FIG. 1. In block 202, the search server 100 receives a search query from the user device 102. For example, the search server 100 may receive the search query in a query wrapper 106 that includes information in addition to the search query.

In block 204, the search server 100 identifies a set of applications based on the received search query. For example, the search server 100 may identify a set of links to native applications and/or web applications. As described herein, the search server 100 may identify the set of applications using one of a function search, an entity search, and a text based search, in some examples. The initial set of application links may be referred to as preliminary search results in the sense that the search server 100 can generate an entity link that can be added to the organic search-result links. As described above, the links can have a variety of different formats and may include text and/or images.

In block 206, the search server 100 determines a set of entities that are associated with one or more of the applications identified in block 204. In some examples, each of the applications may be associated with one or more entities (e.g., one or more entity records). Although the applications may be associated with one or more entities, in some examples, one or more of the applications in the preliminary search results may not be associated with any entities. Accordingly, each entity of the set of entities determined in block 206 may be associated with one or more of the applications in the preliminary search results. The search server 100 may determine the set of entities in block 206 in a variety of different ways described herein.

In block 208, the search server 100 selects one or more of the entities to include in the search results based on bids associated with the entities. For example, the search server 100 may determine which of the entities in the set of entities is associated with a bid. Of those entities that are associated with a bid, the search server 100 may select one or more of the entities to include in the search results based on the magnitude of the bid associated with the one or more entities. For example, the search server 100 may select one or more entities that have the highest bids for insertion into the search results 108. In a more specific example in which the search server 100 selects a single entity for inclusion into the search results, the search server 100 may select the entity having the highest bid for inclusion into the search results 108. Each selected entity may be associated with an entity link to be included in the search results 108. For example, the entity record for the entity may include the entity link to include in the search results 108.

In block 210, the search server 100 transmits the search results 108 to the user device 102. The search results 108 may include links to the applications identified in block 204 along with an entity link determined in block 208. The user device 102 may generate the search result page based on the search results received from the search server 100 in block 210. In some examples, the search server 100 can include the selected entity in the search results 108 by providing a link to a state of an application corresponding to the selected entity. In other examples, the search server 100 can include the selected entity in the search results 108 by providing a view of a state of an application in the search results 108, such as a screen shot or a window into the state of the application referencing the entity. In other examples, the search server 100 may generate an icon or a snippet that displays or otherwise references the selected entity. Additional and alternative implementations of entity bidding and advertising techniques are further described herein.

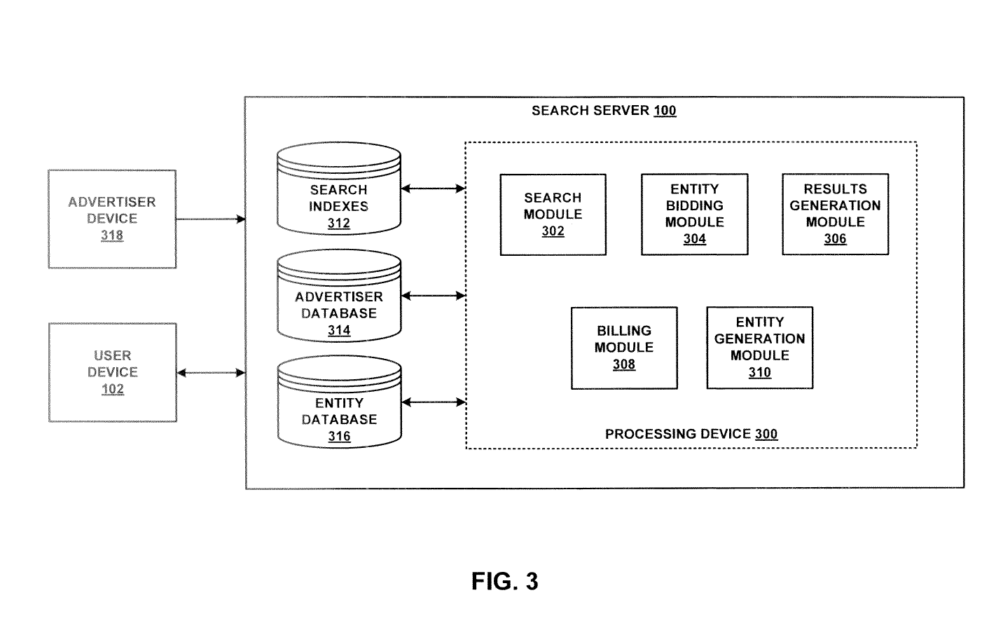

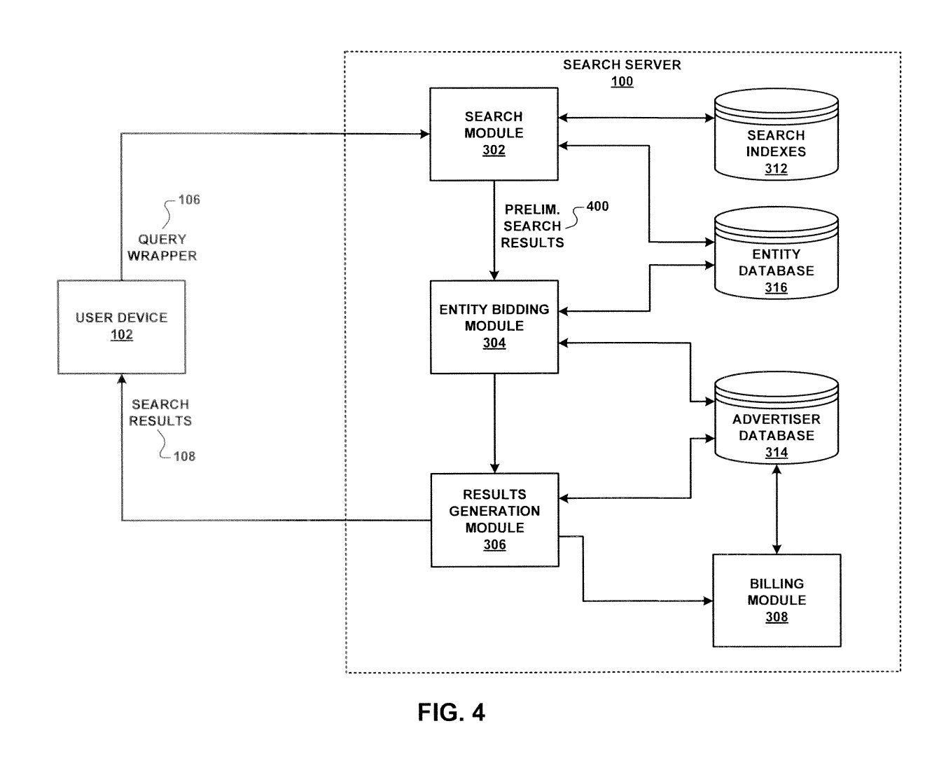

Referring now to FIGS. 3-4, an example of a search server 100 and data flow thereof is illustrated. Although the search server 100 is illustrated as a single box in FIGS. 3-4, the search server 100 may be embodied as one or more computing devices operating in an individual or distributed manner. In these implementations, the multiple computing devices may be located at the same physical location or at different locations. The search server 100 may include a processing device 300 that executes a search module 302, an entity bidding module 304, a results generation module 306, a billing module 308, and an entity generation module 310. The search server 100 may further include one or more search indexes 312, an advertiser database 314, and an entity database 316, which can be stored on one or more storage devices of the search server 100.

The processing device 300 can include one or more processors that execute machine-readable instructions stored on a computer readable medium or media (e.g., RAM and/or ROM). In implementations where the processing device 300 includes more than one processor, the processors can operate in an individual or distributed manner. Furthermore, the processing device 300 can be shared over multiple physical devices. The search module 302, the entity bidding module 304, the results generation module 306, the billing module 308, and the entity generation module 310 may be embodied as machine readable instructions that are executed by the processing device 300.

The search module 302 receives a query wrapper 106 and determines preliminary search results 400 based thereon. In particular, the search module 302 determines one or more applications (e.g., application states) that are relevant to the search query contained in the query wrapper 106, and in some scenarios, the additional information contained in the query wrapper 106. The search module 302 can perform one or more of a function search, an entity search, and a text search by leveraging the one or more search indexes 312 and/or the entity database 316. The search results determined by the search module 302 are preliminary search results 400, as the search results are not yet associated with entities.

A function search may include a search process by which the search module 302 searches for applications that perform a functionality defined or implied in the search query. Function searching may be different than name searching or keyword searching in that function searching may specify a desired task, function, or feature (e.g., find restaurant, take me to downtown, where to find the best burger). Name searches use the actual name of an application instead of a function performed by the named application (e.g., the user enters “Skype” when the user is looking for the “SKYPE®” application). The terms associated with function searches are often entered by the user in a natural language form. For example, a function search term may be “make video calls to friends overseas,” compared to a name search of “Skype.” In this example, the query does not include the term “Skype,” and the description of the SKYPE® application does not mention the word “friends” or “overseas.” Therefore, traditional keyword searches might not identify the Skype application as being relevant.

Function searching may include searching for an application across multiple platforms. As used herein, a platform can refer to a hardware architecture and/or software framework, the combination of which allows the software to run. Some examples of platforms may include, but are not limited to, the ANDROID®, IOS®, and WINDOWS PHONE® operating systems.

Function searching can be supported by the search indexes 312. The search indexes 312 include data from multiple third party sources such as, but not limited to, digital distribution platforms (e.g., the GOOGLE PLAY® digital distribution platform by Google, Inc. or the APP STORE®® digital distribution platform by Apple, Inc.), blogs, application review sites, application catalogs, and/or application developers. Due to the different sources included in the search indexes 312, function searching leverages the multiple data sources and analyzes both the textual and non-textual features and provides the user with a list of the best available applications (e.g., application states) based on inputted search terms.

In some implementations of the search indexes 312, the search indexes 312 may include a plurality of “canonical application” data structures. A canonical application data structure may be a data structure that defines the attributes of one or more related application editions. The application editions are the various different versions of an application, e.g., a free version for a first platform, a pay version for the first platform, and a free version for a second platform. Put another way, a canonical application data structure may be an umbrella data structure that represents the different versions of the same application. Each canonical application data structure can have attributes that are associated with the combination of the application editions, as well as attributes that are associated with each of the application editions themselves. The attributes of a canonical application data structure may be used by the search module 302 to identify applications that perform a specific function.

In operation, the search module 302 receives the search query from the user device 102. In some implementations, the search module 302 determines a set of sub-queries based on the received search query. Each sub-query may represent a different subset of the terms contained in the search query. Furthermore the search module 302 may determine one or more query attributes of the query, e.g., how many words are in the search query, a category implicated by the search query, a platform of the user device 102 sending the query, a language of the query and/or dialect of the query. The search module 302 can query the search indexes 312 with the query and/or the sub-queries. The search module 302 can utilize a combination of heuristics, machine learning, and/or natural language processing techniques to determine a set of relevant applications based on the query, the sub-queries, and the query attributes. The set of relevant applications can be included in the preliminary search results 400.

The set of relevant applications can be pared down to an initial result set based on calculations relating to query-result features, i.e., features of each application in view of the search query. The search module 302 may generate result scores for the initial result using one or more learned scoring models. The applications corresponding to the highest result scores are included in the preliminary search results 400. The foregoing is an example implementation of function searching and not intended to be limiting. It is appreciated that any suitable type of function searching may be implemented by the search module 302. Detailed techniques for performing function search may be found in U.S. patent application Ser. No. 13/842,169, filed on Mar. 15, 2013, the contents of which are hereby incorporated by reference.

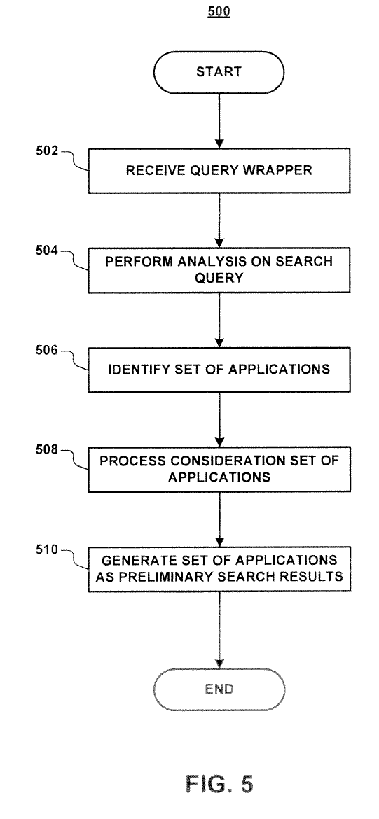

FIG. 5 is a flow diagram of an example method 500 for performing a search for applications (e.g., application links) to include in the search results 108. The method 500 is described herein with reference to the search module 302 of FIGS. 3-4. In block 502, the search module 302 receives the query wrapper 106 including a search query. In block 504, the search module 302 performs analysis on the search query. For example, analysis operations performed by the search module 302 may include, but are not limited to, tokenization of the query, filtering of the query, stemming, synonymization, and stop word removal.

In block 506, the search module 302 identifies a set of applications (e.g., application links) based on the search query (e.g., based on the analyzed search query). The set of applications may be a consideration set of applications, which may be pared down. In block 508, the search module 302 processes the set of applications identified in block 506. For example, the search module 302 may score the set of applications identified in block 506. In some examples, the search module 302 may score the set of applications using one or more learned scoring models, as described above. In block 510, the search module 302 generates the set of applications as preliminary search results 400. For example, the preliminary search results 400 may include the highest scoring applications of the consideration set of applications.

The scoring models (e.g., learned scoring models) implemented by the search module 302 may receive one or more scoring features. Scoring features may be associated with the application and/or the search query. An application scoring feature may be based on any data associated with the application (e.g., the application link). A query scoring feature may include any data associated with the search query, such as a number of words in the search query, the popularity of the search query, and the expected frequency of the words in the search query. An application-query scoring feature may include any data which may be generated based on data associated with both the application and the search query that resulted in identification of the application. For example, application-query scoring features may include, but are not limited to, parameters that indicate how well the terms of the search query match the terms associated with the application.

The search module 302 may score the applications based on at least one of the application scoring features, the query scoring features, and the application-query scoring features. In some examples, the search module 302 may include one or more machine learned models (e.g., a supervised learning model) configured to receive one or more scoring features. The one or more machine learned models may generate result scores based on at least one of the application scoring features, the query scoring features, and the application-query scoring features. For example, the search module 302 may pair the search query with each application and calculate a vector of features for each (query, application) pair. The vector of features may include one or more application scoring features, one or more query scoring features, and one or more application-query scoring features. The search module 302 may then input the vector of features into a machine-learned regression model to calculate a result score for the application (e.g., application link). In some examples, the machine-learned regression model may include a set of decision trees (e.g., gradient boosted decision trees). In another example, the machine-learned regression model may include a logistic probability formula. In some examples, the machine learned task can be framed as a semi-supervised learning task, where a minority of the training data is labeled with human curated scores and the rest are used without human labels.

In some implementations, the search server 100 may access the entity database 316 to perform an entity search. For example, the search module 302 may access the entity database 316 to perform an entity search. An entity search is a search that attempts to identify the categories referenced in a query to identify applications that are relevant to those entities. For example, if a user provides a search query that contains a restaurant name, the search module 302 can identify applications that would be somehow relevant to the restaurant identified in the search query. The search module 302 can include the results of the entity search in the search results and/or can utilize the results to enhance the results produced by the function search. The contents of the entity database 316 and additional uses of the entity database 316 are described hereinafter.

The search server 100 may use the entity database 316 to identify entities that are associated with applications in the preliminary search results 400. The entity database 316 includes a plurality of entity records. Each entity record may represent an entity. Accordingly, the entity database 316 includes data associated with a plurality of different entities. Entity records may include a variety of different types of information. For example, entity records may include at least one of an entity name, one or more entity links, one or more entity categories, one or more subcategories, and an entity information field. The entity database 316 may represent one or more databases, indices (e.g., inverted indices), files, or other data structures that store data related to entities. The entity database 316 can be built off-line or on-line and can be built and maintained by human curation and/or the entity generation module 310. It is noted that the entity records may be generated according to a schema that defines the types of elements that may be included in an entity record.

A variety of different entity records are described with respect to FIGS. 6A-6D. Referring now to FIG. 6A, an example entity record 600 may include an entity name 602 and an entity link 604. An entity name may include a name of a business, product, service, a piece of media content, political organization/figure, public figure, destination, or any other suitable item of commerce which may be advertised in connection with an application. Accordingly, entities that may be advertised can include businesses, products, services, media contents, political organizations/figures, public figures, destination places (e.g., city, state, country), or any other suitable items of commerce referenced in an application. An entity name may include one or more words, numbers, and/or symbols (e.g., punctuation marks). Although an entity name may be the name of a business, products, services, media content, or any other suitable item of commerce referenced in an application, in some examples, the entity names of some entity records may denote other things, such as a person, animal, place, thing, or idea. In one example, the entity name of the entity record for a MCDONALD'S restaurant may be “McDonald's.”

An entity link 604 may include a resource identifier. For example, the entity link 604 may include an application resource identifier that references a state (e.g., a screen or other function) of a native application. In an example where a user selects an entity link including an application resource identifier, the user device 102 may launch the native application referenced in the application resource identifier and set the referenced native application in a state specified by the application resource identifier. The entity link 604 may reference an application (e.g., a native application) that is associated with the entity name 602. For example, an entity record corresponding to a movie, e.g., “TOY STORY®,” may include an entity link (e.g., resource identifiers) to the IMDB® application by IMDB, Inc.

As described above, in some examples, an entity record may include multiple different entity links. In these examples, the entity links may indicate multiple applications that are associated with the entity name. Additionally, in these examples the entity record may include multiple different resource identifiers. For example, if the entity record is for the movie “TOY STORY®,” the entity record may include entity links to additional applications, such as the NETLIX® application by Netflix, Inc., the ROTTEN TOMATOES® application, the AMAZON® application by Amazon Inc., the GOOGLE PLAY® application, and the ITUNES® application by Apple, Inc. These applications may be associated with the entity “TOY STORY®” because the applications may reference the movie, sell the movie, stream the movie, and/or review the movie, for example. Accordingly, as described above, an entity record may indicate the applications that are associated with the entity. Although FIGS. 6A-6D illustrate entity links in each entity record, some entity records may not include entity links.

Referring now to FIG. 6B, an entity record 606 may include an entity category 608 that indicates a category in which the entity name 610 and other data in the entity record 606 belongs. For example, the entity category 608 may indicate a category in which the entity link 612 and the entity information 614 (FIG. 6D) belongs. An entity category may include one or more words, numbers, and/or symbols (e.g., punctuation marks). An entity category may be a noun in some examples. Example entity categories include, but are not limited to, “music,” “book,” “game,” “airport,” “movie,” “TV show,” “actor,” “restaurant,” “city,” “country,” and “time.”

In some implementations, as illustrated in the entity record 616 of FIG. 6C, some of the categories may be further broken down into subcategories. Accordingly, an entity record may include one or more categories and subcategories. Put another way, each entity may represent a species of one or more categories and/or subcategories. For example, the category “movie” may include the subcategories “drama,” “comedy,” “romantic comedy,” “kids,” “action,” and “horror.” Similarly, the category “restaurant” may be further broken down into the subcategories “fast food,” “fine dining,” “diners,” “cafes,” “lunch,” “trendy,” “Chinese,” “Mexican” and any other suitable categories. For example, an entity record for the movie “TOY STORY®” may be a species of the category “movie” and the subcategory “kids.” As another example, another entity record for the book named “TOY STORY®” distributed by Disney Enterprises, Inc. may be a species of the category “books” and the subcategory “coloring books.” In another example, the entity for the restaurant chain “CHIPOTLE®” owned by Chipotle Mexican Grill, Inc. may be a species of the category “restaurant” and the subcategories “fast food” and “Mexican.” As an additional example, the entity record for DENNY'S® may include the categories/subcategories for “late night food,” “breakfast food,” “lunch and dinner,” “diner,” and/or “comfort food.”

Referring now to FIG. 6D, an entity record 618 can include entity information 614. Entity information 614 may include various types of information relating to an entity. The entity information 614 may also point to one or more sources of the information. For example, the entity information 614 may include one or more resource identifiers (e.g., application resource identifiers and/or web resource identifiers) from which the information was retrieved. In a more specific example, if the entity record 618 is for the movie “TOY STORY®,” the entity information 614 may include names of the actors who starred in the movie, a synopsis of the movie, reviews of the movie, and one or more resource identifiers that indicate the native applications and/or websites that provided the information.

Entity information may include structured, semi-structured, and/or unstructured data. In some examples, the entity information 614 may include data that is associated with a defined data field. In some implementations, the defined data fields may be tailored to the entity category 620 of the entity record 618. For example, the entity information for an entity record having a movie entity category may include data fields for actor(s), director(s), and producer(s). As another example, entity information for an entity record having a music entity category may include data fields for an artist's name, track names, and track lengths. As another example, entity information for an entity record having a book type may include data fields for an author's name, a publisher, and a publication date.

In some examples, the entity information 614 may include data that is not specifically associated with a defined data field, but instead, may be in free form, such as text from websites, review articles, wiki articles, or other sources. For example, entity information for a movie entity category may include critic reviews and plot summaries. As another example, entity information for a book entity category may include unstructured data, such as book synopses, book reviews, and passages from the book.

In some implementations, an entity record may also include an entity identifier (hereinafter “entity ID”) that identifies the entity record amongst the other entity records included in the entity database 316. For example, the entity ID may uniquely identify the entity record. The entity ID may be a string of alphabetic, numeric, and/or symbolic characters (e.g., punctuation marks) that uniquely identify the entity record in which the entity ID is included.

As described above, in some implementations of the search server 100, the search module 302 may use the entity database 316 during the search for applications. In these implementations, the search module 302 receives the search query and initiates an entity search. The search module 302 provides a database request to the entity database 316 that includes entities or likely entities found in the query. The entity database 316 returns the entity records of the entities identified in the search query. The search module 302 can then determine which applications are relevant to the returned entity records. The search module 302 may be further configured to perform heuristics to score each entity type/third party application match by estimating a probability of whether the entity match is a good match. Additionally, or alternatively, once the probability calculations have been performed, the entity search results are provided as a signal to the function search process described above. For example, if a search module 302 receives the search query “toy story,” the search module 302 identifies the “TOY STORY” entity record in the entity database 316. “TOY STORY” may be categorized as a movie. Therefore, the category “movie” may be provided to the function search process so that the search results may include applications (e.g., application links) directed to movies, such as the IMDB® application and the ROTTEN TOMATOES® application, but do not include “toy story” in their title or description. If a search query is associated with more than one category, multiple categories may be added to the function search. Accordingly, the entity search may allow the search server 100 to identify additional applications for inclusion into the preliminary search results 400 and the final search results 108 sent to the user device 102.

As described herein, the search server 100 may select an advertised entity to include along with the preliminary set of search results 400. An advertiser may sponsor an entity to be included as an advertised entity in the search results. For example, the advertiser may select an entity name to advertise and then set a bid on the entity name. The bid may indicate an amount of money for a specific action in association with the entity (e.g., entity link) in the search results 108. The advertiser's selection of the entity name and the bid may be included in an advertisement entry in the advertiser database 314.

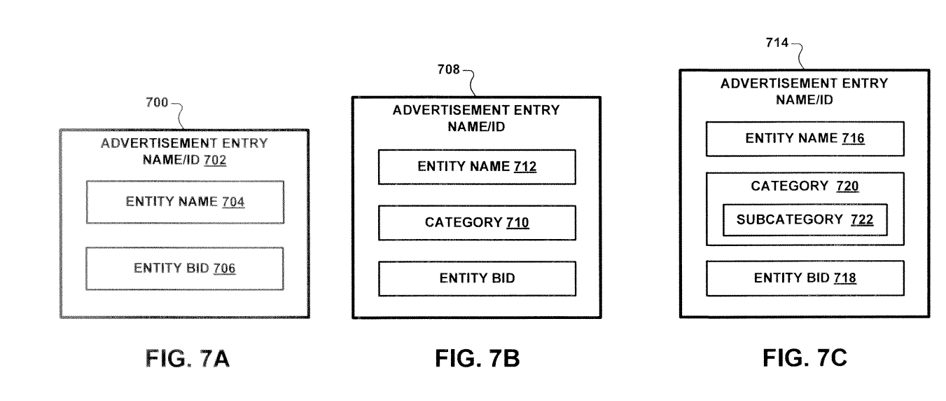

The search server 100 includes an advertiser database 314 that the search server 100 may use to generate advertisements for entities (e.g., entity links). The advertiser database 314 includes data associated with a plurality of different entity advertisements. The data associated with an entity advertisement may be referred to as an “an advertisement entry” (e.g., advertisement entry 700 of FIG. 7A). The advertiser database 314 may include a plurality of advertisement entries that each include data for a different entity advertisement. The advertisement entries may be generated by advertisers, using a computing device (e.g., advertiser device 318), that desire their sponsored entities to be advertised along with organic search results generated by the search server 100.

As described above, an advertiser can place a bid on an entity (e.g., an entity name). In some examples, an advertiser can place a bid on an entity name in association with a category and subcategory, as illustrated in FIGS. 7B-7C. The advertisement entries represent the data related to an entity advertisement that was entered by the advertiser. The search server 100 may use the data included in an advertisement entry in order to generate an entity advertisement for the search results.

Referring now to FIG. 7A, an advertisement entry 700 in the advertiser database 314 may include a variety of different types of data related to an entity advertisement. An advertisement entry 700 may include data that identifies the advertisement entry 700. For example, the advertisement entry 700 may include an advertisement entry name and/or advertisement identifier (i.e., an “advertisement ID”) 702 that identifies the advertisement entry 700 among the different advertisement entries in the advertiser database 314. The advertisement entry name/ID 702 may be assigned to the advertisement entry 700 so that the advertisement entry 700 can be identified for modification/deletion by the advertiser and/or the operator of the search server 100.

An advertisement entry 700 may also include a sponsored entity name 704 that identifies a sponsored entity associated with the advertisement entry 700. A sponsored entity name 704 may be the entity name selected by the advertiser for advertisement. For example, an advertiser may select the entity name 704 and set the entity bid price 706 for the entity name in order to generate the advertisement entry 700.

With respect to FIG. 7B, in some examples, an advertisement entry 708 may include an entity category 710 along with an entity name 712. The advertisement entry 708 of FIG. 7B may be generated when the advertiser specifies an entity category in association with an entity name. With respect to FIG. 7C, an advertisement entry 714 may include an entity name 716, an entity bid 718, an entity category 720, and an entity subcategory 722 of the entity category 720. The advertisement entry 714 of FIG. 7C may be generated when the advertiser specifies an entity category 720 and entity subcategory 722 in association with an entity name 716.

Although not illustrated in FIGS. 7A-7C, in some examples, an advertisement entry may include advertisement content. Advertisement content may include data that is used to generate an advertisement for the sponsored entity. For example, advertisement content may include text and/or images (e.g., icons) that may be included in the entity link displayed on the user device 102. Additionally, an advertisement entry may include other advertising parameters related to advertising the entity. For example, the advertisement parameters may define budgets associated with advertising the entity, timing parameters associated with advertising the entity (e.g., start and stop dates), and other parameters.

An advertisement entry may correspond to one or more entity records. For example, if an advertisement entry includes an entity name, but does not define an entity category, the entity name included in the advertisement entry may be associated with one or more entity records having the entity name. In this example, the multiple entity records associated with the same advertisement entry may each have different entity categories. In another example, a single advertisement entry may be associated with a single entity record. For example, if the single advertisement entry includes an entity name and entity category that collectively correspond to a single entity record having the same entity name and entity category, the single advertisement entry may be associated with the single entity record. As described herein, the search server 100 can determine which entities (e.g., entity name and category/subcategory) to advertise in the search results 108 based on the correspondence between the advertisement entries and the entity records. For example, the search server 100 can determine which entity links to add in the search results 108 based on the correspondence between the advertisement entries and the entity records.

Referring back to FIGS. 3-4, as described above, the search module 302 may receive the search query and identify a set of applications (e.g., links) that may form the preliminary search results 400. The entity bidding module 304 of the search server 100 may determine which entities to include in the search results. For example, as described above with respect to block 206 of FIG. 2, the entity bidding module 304 may determine a set of entities that are associated with one or more of the identified applications. In some examples, the entity bidding module 304 may determine which entities are associated with applications in the preliminary search results 400 using the entity records included in the entity database 316. In other examples, the entity bidding module 304 may determine which entities to include in the search results using “search forwarding” techniques described herein.

In some implementations of the entity bidding module 304, the entity bidding module 304 determines which entity link to include in the search results 108 by initially identifying entity records associated with the applications in the preliminary search results 400. For example, the entity bidding module 304 may determine which entities are associated with the applications based on the application(s) referenced in the entity links of the entity records or based on an enumerated list of applications in the entity records, as described above. Then the entity bidding module 304 may determine which entity to advertise based on whether a bid is associated with the entity and based on the magnitude of the bid associated with the entity. For example, assuming that an advertiser generated an advertisement entry including an entity name and a bid, the entity bidding module 304 may determine that a bid is associated with an entity record when the entity bidding module 304 identifies an advertisement entry that includes the entity name and an entity bid.

In some implementations of the search server 100, the search module 302 and/or the entity bidding module 304 may determine a category implicated by the search query. In these examples, assuming that an advertiser generated an advertisement entry including an entity name, an entity category, and a bid, the entity bidding module 304 may determine that a bid is associated with an entity record when the entity bidding module 304 identifies an advertisement entry that includes the entity name and the entity category of the entity record. As a further example, assuming that an advertiser generated an advertisement entry including an entity name, an entity category, a subcategory, and a bid, the entity bidding module 304 may determine that a bid is associated with an entity record when the entity bidding module 304 identifies an advertisement entry that includes the entity name, the entity category, and the subcategory of the entity record.

In some implementations, the entity bidding module 304 can determine the entities to include in the search results using “search forwarding” techniques. The entity bidding module 304 can determine the entities to include using search forwarding based on a local ontology of each application returned in the preliminary search results 400, or a global ontology. In these implementations, the entity bidding module 304 receives the preliminary search results 400 from the search module 302 and may also receive the query wrapper 106. The entity bidding module 304 determines which entities to include in the search results based on the preliminary search results 400 and the query wrapper 106. For example, the entity bidding module 304 identifies entities to include in the search results by performing search forwarding on the applications indicated in the preliminary search results 400. Search forwarding includes providing the search query contained in the query wrapper 106 to an application that has been identified as a candidate to show up on the search result page. In one example, the entity bidding module 304 can utilize an application programming interface (API) to provide the search query to an application server (not shown) or web server (not shown) of the application. In some implementations, the entity bidding module 304 utilizes a schema of the application to generate a resource identifier that can be used to access a results page on the application corresponding to the search query. The schema of the application defines the structure of resource identifiers generated by the application. The entity bidding module 304 receives results from the application, whereby the results may indicate different entities which may or may not have a bid associated therewith.

After the entity bidding module 304 determines which entities may be advertised based on the identification of the entity records, the entity bidding module 304 may select an entity to advertise based on the magnitude of the bids associated with the entities. For example, the entity bidding module 304 may select the highest bid(s) amongst the identified entity records, as indicated in the advertisement entries. As described hereinafter, the results generation module 306 generates entity links based on the entity record(s) selected by the entity bidding module 304.

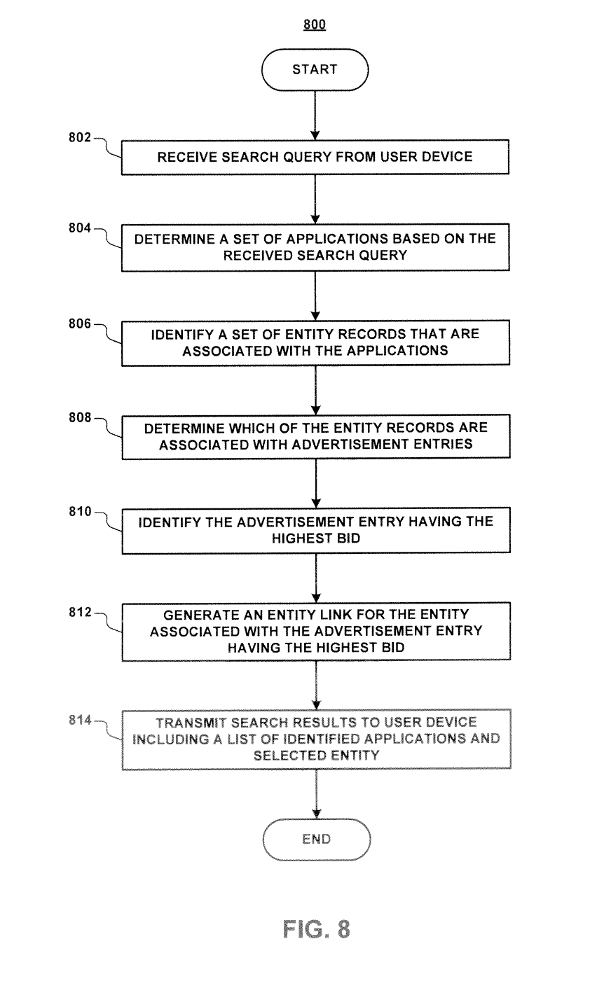

FIGS. 8-10 are flow diagrams that describe example implementations of the search server 100. Referring now to FIG. 8, an example method 800 for generating an entity link within search results is described. In block 802, the search module 302 receives the search query from the user device 102. In block 804, the search module 302 determines a set of applications (e.g., preliminary search results 400) based on the received search query.

In block 806, the entity bidding module 304 may identify a set of entity records that are associated with the applications (e.g., application links) of the preliminary search results 400. In block 808, the entity bidding module 304 determines which of the entity records are associated with advertisement entries. In block 810, the entity bidding module 304 identifies an associated advertisement entry that includes the highest bid.

In block 812, the results generation module 306 generates an entity link for the entity record associated with the advertisement entry having the highest bid. For example, the results generation module 306 may use the entity link included in the identified entity record. If the entity record includes multiple entity links, the results generation module 306 may select the entity link associated with the application of the preliminary search results 400 that resulted in identification of the entity record. In block 814, the results generation module 306 transmits the search results 108 to the user device 102. The search results 108 may include links to the applications identified in the preliminary search results 400 and the entity link. Example operation of the results generation module 306 is described hereinafter.

The results generation module 306 receives the search results generated by the entity bidding module 304 and generates search results 108 to be included in a search result page for display at the user device 102. In some implementations, the results generation module 306 can determine a link corresponding to each entity selected by the entity bidding module 304. For example, if an entity “DENNY'S®” was selected for the YELP® application and the entity “IHOP®” was selected for the URBANSPOON® application, the results generation module 306 may generate a link (e.g., a native application link) to a DENNY'S® page on the YELP® application and a second link (e.g., a native application link) to an IHOP® page on the URBANSPOON® application. The links generated by the results generation module 306 may include application resource identifiers and/or web resource identifiers. The results generation module 306 may arrange the links in the search result page in any suitable manner.

Additionally or alternatively, the results generation module 306 can generate an entity link including a view corresponding to each entity selected by the entity bidding module 304. For example, the results generation module 306 can obtain a screen shot of a state of an application (e.g., native or web application) corresponding to the entity. Using the example from above, the results generation module 306 may obtain a first screenshot of the DENNY'S® page of the YELP® native application and a second screenshot of the IHOP® page of the URBANSPOON® native application. The entity links including the views corresponding to each entity may include resource identifiers (e.g., application or web resource identifiers) so that a user may select (e.g., tap or click) the entity links including the views in the search results page to launch the application to a state according to the included resource identifiers. For example, an entity link including an application resource identifier may launch a native application and set the native application into a state corresponding to the view included in the entity link. The results generation module 306 may arrange the views in the search result page in any suitable manner. The results generation module 306 can provide the search result page to the user device 102.

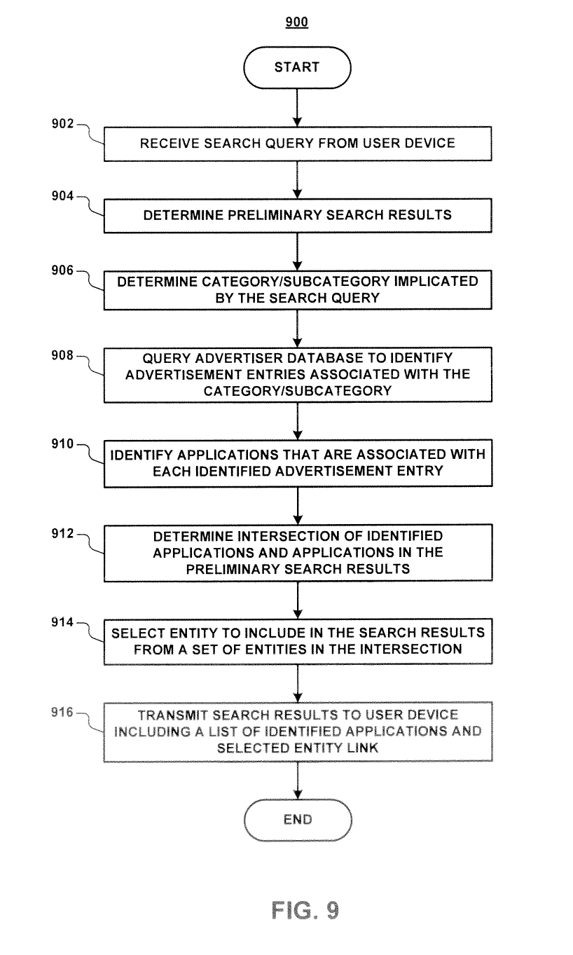

FIG. 9 describes another example method 900 for generating an entity link within search results. In block 902, the search module 302 receives the search query from the user device 102. In block 904, the search module 302 determines a set of preliminary search results 400. In block 906, the entity bidding module 304 identifies a category/subcategory implicated by the search query. In some examples, the search module 302 may determine the category/subcategory implicated by the search query.

In block 908, the entity bidding module 304 determines the entities in the advertiser database 314 that are associated with the category and/or subcategories and retrieves each determined entities' respective entity bid record from the advertiser database 314. The number of entities that are matched to a broad category may be too large as the category may be too inclusive. For example, a search query for “fancy restaurants to take a date” may implicate the category “restaurants.” Assuming a fast food chain has provided a bid in the advertiser database 314 under the category “restaurants,” the fast food chain's entity would match to the category “restaurants.” In such a scenario, the fast food chain may not be relevant to the search query but could potentially be included in the search results 108 because it matches to the broad category. To reduce the likelihood of such an occurrence, some implementations of the entity bidding module 304 may further take into account the subcategories of the entities listed in the advertiser database 314 to determine whether an entity is implicated by the search query. For example, the entity bidding module 304 may disregard an entity unless it matches to at least one subcategory implicated by the search query. Thus, in the example provided above, the entity of the fast food chain would be disregarded as the subcategories of the fast food chain do not match the subcategories implicated by the search query.

In some implementations, the advertiser database 314 may be indexed by category and subcategory. Further, entities may be associated with one or more category or subcategory. Furthermore, each entity/category association can include a bid amount. For example, a category may be “retail stores,” an entity may be NORDSTROM®, and the advertiser (e.g., NORDSTROM®) may agree to pay fifteen cents per impression. In this example, the advertiser database 314 may store an entry indicating an association of NORDSTROM® to the category “retail stores” and indicating a bid price of fifteen cents per impression. Thus, when the entity bidding module 304 queries the advertiser database 314 with the category “retail stores,” the advertiser database 314 may return the entity “NORDSTROM®” and any other entities that are associated with “retail stores.” Furthermore, in some implementations, the advertiser database 314 may further include stipulations placed on each bid. For example, the advertiser of the entity “NORDSTROM®” may limit the bid to only apply to search queries received from major metropolitan areas having a NORDSTROM® brick and mortar location.

In block 910, the entity bidding module 304 determines a set of applications that are associated with each bid-on entity that is implicated or relevant to the search query. As described herein, each entity record can include or point to a list of applications that are associated with the entity. For example, if a web application includes a review of an entity, sells an entity, describes an entity, or provides information regarding the entity, the entity record may include a reference, e.g., pointer, to the web resource identifier from which the information was obtained. In this way, each entity record identifies the web applications and native applications that were used to create the entity record. Thus, the entity bidding module 304 can obtain the applications that are associated with an entity from the entity's corresponding entity record.

In block 912, the entity bidding module 304 determines an intersection between the set of applications associated with the entity and the set of applications in the preliminary search results 400. The intersecting set of applications represents the applications that are associated with the entity and are relevant to the search query. Of these applications, the entity bidding module 304 can select one or more of the applications in the intersecting set of applications. In block 914, the entity bidding module 304 determines whether to include an entity link in the search results in relation to one or more of the selected applications. The entity bidding module 304 can make this determination based on the bid amount associated with the entity, the bid amounts of the other identified entities, and any other suitable criteria. In this way, the entity bidding module 304 determines the search results 108. In block 916, the results generation module 306 transmits the search results 108 including the search-result links and the selected entity link(s).

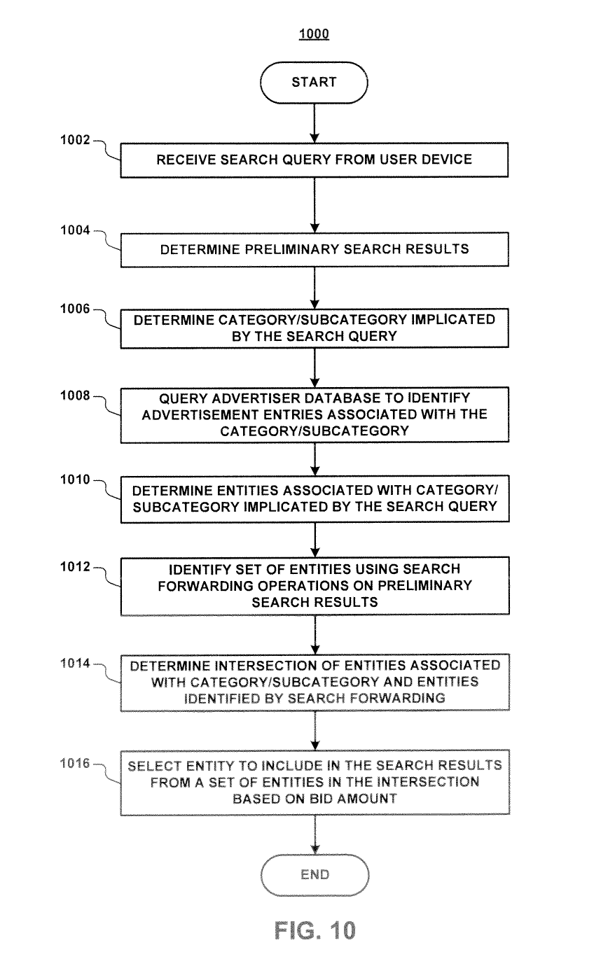

FIG. 10 describes another example method 1000 for generating an entity link within search results. In block 1002, the search module 302 receives the search query from the user device 102. In block 1004, the search module 302 determines a set of preliminary search results 400. In block 1006, the entity bidding module 304 identifies a category/subcategory implicated by the search query. In some examples, the search module 302 may determine the category/subcategory implicated by the search query.

In block 1008, the entity bidding module 304 determines the entities referenced in the advertiser database 314 (e.g., advertisement entries) that are associated with the category and/or subcategories and retrieves each determined entities' respective advertisement entry from the advertiser database 314. In this manner, the entity bidding module 304 determines entities (e.g., entity records) that are associated with the category/subcategory implicated by the search query in block 1010. In block 1012, the entity bidding module 304 identifies a set of entities by performing search forwarding operations on the applications indicated in the preliminary search results 400.

In block 1014, the entity bidding module 304 determines an intersection between a first set of entities identified from the search forwarding processes and a second set of entities associated with the category/subcategory implicated by the search query. The intersecting set of entities is comprised of the entities that can potentially be included in the search results 108. In block 1016, the entity bidding module 304 selects one or more of the entities to be included in the search results 108 based on bid amounts and other criteria associated with the entities, such as the stipulations associated with each bid and the amount of times each entity has been included in search results over a given period of time. The entity bidding module 304 may utilize a set of rules for selecting the entity to be included in the search results. For example, a rule may call for the entity with the highest bid amount to be included in the search results, unless the stipulations placed on the bid preclude such inclusion. The entity bidding module 304 can include an entity link for one or more of the applications indicated in the preliminary search results 400, thereby generating the search results 108.

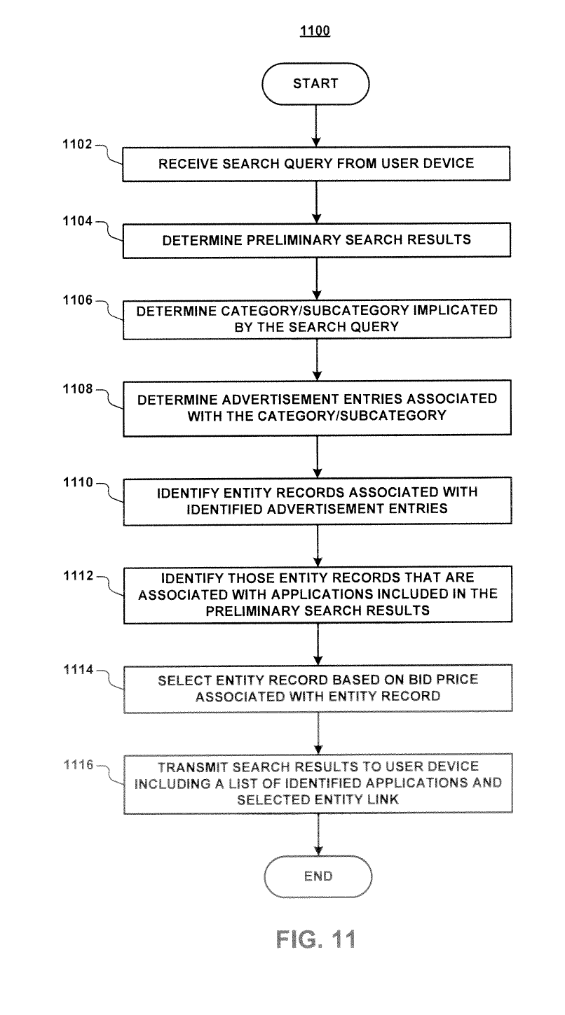

FIG. 11 describes another example method 1100 for generating an entity link within search results. In block 1102, the search module 302 receives the search query from the user device 102. In block 1104, the search module 302 determines a set of preliminary search results 400. In block 1106, the entity bidding module 304 identifies a category/subcategory implicated by the search query. In some examples, the search module 302 may determine the category/subcategory implicated by the search query.

In block 1108, the entity bidding module 304 identifies advertisement entries in the advertiser database 314 that are associated with the category and/or subcategories determined in block 1106. In block 1110, the entity bidding module 304 identifies entity records associated with the advertisement entries identified in block 1108. For example, the entity bidding module 304 may identify entity records having the same entity category/subcategory and/or entity name as the advertisement entries identified in block 1108.

In block 1112, the entity bidding module 304 further filters the entity records identified in block 1110 by identifying entity records that are associated with at least one of the applications included in the preliminary search results. In block 1114, the entity bidding module 304 selects one or more of the entity records identified in block 1112 based on the bid price associated with the entity records. For example, the entity bidding module 304 may select one or more of the entity records having the highest bid price. In block 1116, the results generation module 306 transmits the search results 108 including the search-result links to the preliminary search results and the entity link(s) of the entity records selected in block 1114.

FIGS. 12A-12B illustrate example GUIs that the user device 102 may generate. FIG. 12A includes search-result links 120 and an entity link 122 generated by the search server 100 in response to a search query “late night diners,” as described above with respect to FIG. 1. FIG. 12B shows an example GUI for a DENNY'S® restaurant entry in the TRIPADVISOR® native application generated by the user device 102 after the user selects the entity link 122. For example, as described above, in response to user selection of the entity link 122, the user device 102 launched the TRIPADVISOR® native application and set the TRIPADVISOR® native application into a state that accesses a DENNY'S® restaurant entry.

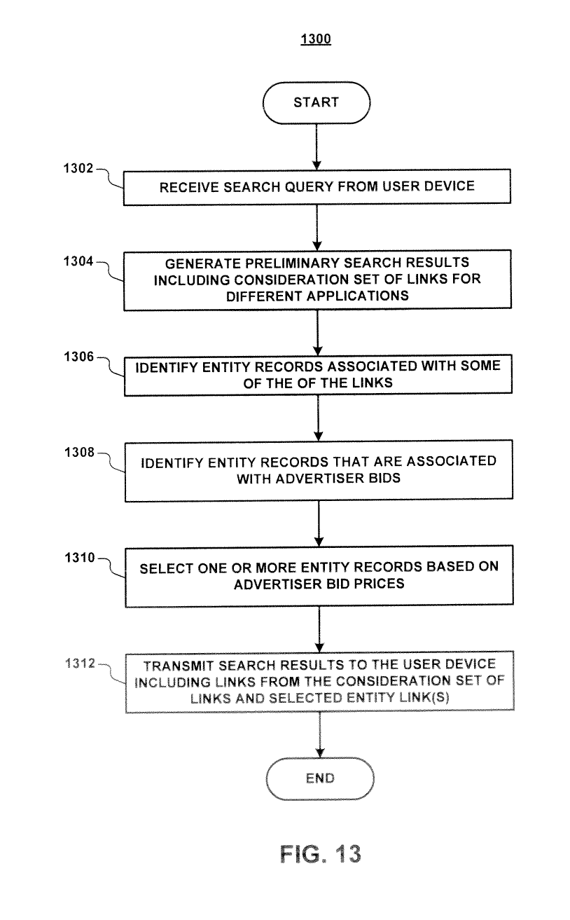

FIG. 13 describes another example method 1300 for generating an entity link within search results. In block 1302, the search module 302 receives the search query from the user device 102. In block 1304, the search module 302 determines a set of preliminary search results 400 that include a consideration set of links (e.g., native application links) for a plurality of different applications. Some of the links may be included in the search results 108 as organic search results, as described above. In some examples, the search module 302 may not include all of the preliminary search results 400 in the search results 108, e.g., in order to prevent an excessive number of search results (e.g., links) from being displayed on the user device 102. Accordingly, a set of additional preliminary search results (e.g., a set of additional links) may not be included in the search results 108.

In block 1306, the entity bidding module 304 identifies entity records associated with at least some of the links determined in block 1304. For example, the entity bidding module 304 may identify entity records associated with the organic links of the preliminary search results 400 that are not included in the search results 108 transmitted to the user device 102 (e.g., the set of additional links). Put another way, the entity bidding module 304 may identify entity records associated with those links that were organically generated, but may not be included in the search results 108. The entity bidding module 304 may identify the entity records that are associated with the links in by detecting matches between the links and the entity links included in the entity records. For example, a link in the preliminary search results 400 may match an entity link in an entity record.

In block 1308, the entity bidding module 304 identifies which of the entity records identified in block 1306 are associated with advertiser bids. In block 1310, the entity bidding module 304 selects one or more entity records identified in block 1308 based on the advertiser bids associated with the entity records. For example, the entity bidding module 304 may select the entity records associated with the highest bids. In block 1312, the results generation module 306 transmits the search results 108 including the search-result links of the preliminary search results 400 and the entity link(s) of the entity records selected in block 1310. The entity link(s) transmitted in block 1312 may be the link(s) that were originally included in the preliminary search results 400, but were not set to be added to the final search results 108 as organic results. Accordingly, the entity bidding and advertising technique of FIG. 13 may allow for the inclusion of bid-on entity link(s) that may otherwise be excluded from the organic search results.

Referring back to FIGS. 3-4, the search server 100 may include a billing module 308. The billing module 308 monitors each time an entity is included in the search results and, in some implementations, actions that are performed on the search results, e.g., whether the user selected the entity in the search results. In this way, the billing module 308 can determine how much to charge an advertiser.

As illustrated in FIG. 3, the search server 100 may include an entity generation module 310. The entity generation module 310 generates and updates entity records. The entity generation module 310 can implement one or more web crawlers that analyze the collection of documents on the world-wide web. The web crawler may utilize a list of known resource identifiers, e.g., application resource identifiers and web resource identifiers, to obtain the documents corresponding to the resource identifiers. In some implementations, the entity generation module 310 may store the documents locally at the search server 100. The entity generation module 310 may scrape the documents to identify an entity in the document and data items relating to the entity. As can be appreciated, the entity may be referenced in more than one document. For example, a restaurant may be reviewed on a YELP® page and an URBANSPOON® page. Additionally, the location of the restaurant may be referenced in a maps application.

The entity generation module 310 can merge the data compiled from all of the scraped documents, but may also maintain the source of each chunk of scraped data. The entity generation module 310 can then extract various features from the merged data. As the entity generation module 310 extracts the features, the entity generation module 310 can tag the extracted features according to a schema that defines the structure of the entity records. In this way, the entity generation module 310 may normalize and structure the data. The entity generation module 310 may then either create a new entity record based on the normalized, structured data, or may update a pre-existing entity record with the normalized, structured data. In the latter scenario, an entity record corresponding to the identified entity is stored in the entity database 316. The entity generation module 310 can continuously crawl the World Wide Web to maintain the entity database 316. It is noted that the entity records may be created in other suitable manners. For instance, the entity records may be human curated, such that a human analyzes a document and creates the entity record based on his or her analysis.

Although a few examples have been described in detail above, other modifications are possible. For example, the flow diagrams depicted in the figures do not require the particular order shown, or sequential order, to achieve desirable results. Other steps may be provided, or steps may be eliminated, from the described flow diagrams, and other components may be added to, or removed from, the described systems. Other embodiments may be within the scope of the following claims.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, a data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks: and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such backend, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
generating preliminary search results based on a search query received from a user device, the preliminary search results including search-result links to a plurality of native applications;
identifying a plurality of entity records based on the search query, each of the entity records including an association with one of the plurality of native applications of the preliminary search results, wherein each of the entity records includes an entity name and an entity link, and wherein each entity link includes a reference to a state of a native application associated with the entity name of the entity record in which the entity link is included;
selecting one of the entity records based on an advertiser bid price associated with the one of the entity records;
retrieving the entity link from the selected one of the entity records; and
transmitting the search-result links and the retrieved entity link to the user device.

2. The method of claim 1, wherein generating preliminary search results comprises generating the preliminary search results based on the relevance of the preliminary search results to terms of the search query.

3. The method of claim 1, wherein each of the search-result links includes a reference to a different native application along with instructions for the respective native application to launch on the user device.

4. The method of claim 1, wherein N of the plurality of entity records each include a field that lists one or more native applications with which the entity record is associated, wherein N is an integer that is greater than or equal to 1.

5. The method of claim 1, wherein, for each entity record, the entity link included in the entity record indicates which native application is associated with the entity record.

6. The method of claim 1, wherein one of the entity records includes an entity information field along with the entity name and the entity link, wherein the entity information field includes information about the entity name, and wherein the reference to the state of the native application included in the entity link is a reference to the location from where the information of the entity information field was retrieved.

7. The method of claim 1, wherein transmitting the retrieved entity link to the user device comprises transmitting data indicating that the retrieved entity link is an advertisement.

8. The method of claim 1, wherein the state of the native application referenced in an entity link includes data related to the entity name.

9. The method of claim 8, wherein the entity name is the name of a product for sale in the state of the native application.

10. The method of claim 8, wherein the entity name is the name of a business described in the state of the native application.

11. The method of claim 1, wherein selecting one of the entity records based on the advertiser bid price associated with the one of the entity records comprises identifying an advertisement entry in an advertisement database, wherein identifying the advertisement entry comprises detecting an entity name included in the advertisement entry that matches the entity name in the one of the entity records.

12. The method of claim 1, wherein selecting one of the entity records comprises:
determining advertiser bid prices associated with each of the plurality of entity records; and
selecting the one of the entity records that is associated with the highest bid price of the determined advertiser bid prices.

13. The method of claim 1, wherein identifying the plurality of entity records comprises performing a search forwarding operation, the search forwarding operation comprising:
providing the search query to servers of one or more of the plurality of native applications of the preliminary search results;
receiving results from the servers of the one or more of the plurality of native applications; and
identifying the plurality of entity records based on the received results.

14. The method of claim 1, further comprising determining a category implicated by the search query, wherein identifying the plurality of entity records comprises identifying entity records that include an entity category that matches the category implicated by the search query, the entity category of an entity record indicating a category to which the entity name and entity link of the entity record belong.

15. The method of claim 14, wherein selecting the one of the entity records comprises identifying an advertisement entry among a plurality of advertisement entries in an advertiser database, wherein identifying the advertisement entry comprises determining that the advertisement entry includes an entity category that matches the entity category included in the one of the entity records, wherein the advertisement entry further includes the advertiser bid price.

16. The method of claim 1, further comprising determining a category and a subcategory implicated by the search query, wherein identifying the plurality of entity records comprises identifying entity records that include both an entity category and an entity subcategory that match the category and the subcategory implicated by the search query, respectively, the entity category and entity subcategory of an entity record indicating a category and subcategory to which the entity name and entity link of the entity record belong.

17. The method of claim 1, wherein generating the preliminary search results comprises generating the preliminary search results based on the relevance of the preliminary search results to terms of the search query, wherein the preliminary search results include the search-result links and a set of additional links to native applications, wherein identifying the plurality of entity records comprises identifying entity records that include an entity link that matches at least one of the additional links, and wherein retrieving the entity link for transmission comprises using one of the additional links that match one of the entity links.

18. A system comprising:
a storage device storing an entity database that includes a plurality of entity records, each of the entity records including an association with a native application, wherein each of the entity records includes an entity name and an entity link, and wherein each entity link includes a reference to a state of the native application associated with the entity name of the entity record in which the entity link is included; and
a processing device that executes computer readable instructions, the computer readable instructions, when executed by the processing device, causing the processing device to:
generate preliminary search results based on a search query received from a user device, the preliminary search results including search-result links to a plurality of native applications;
identify a set of entity records in the entity database, wherein identifying each entity record in the set of entity records comprises determining that the entity record includes an association with one of the plurality of native applications of the preliminary search results;
select one of the entity records in the set of entity records based on an advertiser bid price associated with the one of the entity records;
retrieve the entity link from the selected one of the entity records; and
transmit the search-result links and the retrieved entity link to the user device.

19. The system of claim 18, wherein each of the search-result links includes a reference to a different native application along with instructions for the respective native application to launch on the user device.

20. The system of claim 18, wherein the computer readable instructions cause the processing device to transmit the retrieved entity link to the user device along with data indicating that the retrieved entity link is an advertisement.

21. The system of claim 18, wherein the state of the native application referenced in an entity link includes data related to the entity name.

22. The system of claim 18, wherein the storage device stores an advertiser database that includes a plurality of advertisement entries, each of the advertisement entries including an entity name and an advertiser bid price, wherein the computer readable instructions cause the processing device to:
identify a set of advertisement entries in the advertiser database that include entity names that match entity names included in the set of entity records;
select an advertisement entry in the set of advertisement entries based on the advertiser bid price associated with the advertisement entry; and
select the one of the entity records that includes the same entity name as the selected advertisement entry.

23. The system of claim 18, wherein N of the entity records in the entity database include entity categories that indicate a category to which the entity name and entity link of the entity record belong, wherein the computer readable instructions cause the processing device to:
determine a category implicated by the search query; and
identify the set of entity records by identifying entity records that include an entity category that matches the entity category implicated by the search query, wherein N is an integer that is greater than or equal to 1.

24. A non-transitory computer-readable storage medium comprising instructions that cause a processing device to:
generate preliminary search results based on a search query received from a user device, the preliminary search results including search-result links to a plurality of native applications;
identify a plurality of entity records, each of the entity records including an association with one of the plurality of native applications of the preliminary search results, wherein each of the entity records includes an entity name and an entity link, and wherein each entity link includes a reference to a state of a native application associated with the entity name of the entity record in which the entity link is included;
select one of the entity records based on an advertiser bid price associated with the one of the entity records;
retrieve the entity link from the selected one of the entity records; and
transmit the search-result links and the retrieved entity link to the user device.
